(19) United States
(12) Patent Application Publication
(10) Pub. No.: US 2007/0269202 A1
(43) Pub. Date: Nov. 22, 2007

(54) CAMERA LENS COVER AND REFLECTOR FOR MOBILE STATION

(75) Inventors: Cindy-Kay Forsyth-Martinez, Plantation, FL (US); Chad A. Jackman, Stuart, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/383,777

(22) Filed: May 17, 2006

(51) Int. Cl. G03B 19/00; G03B 17/00

(52) U.S. Cl. 396/429; 396/448

(57) ABSTRACT

A mobile station (100) having an integrated camera (105). The mobile station (100) can include a camera lens (115) disposed in the mobile station (100) and a lens cover (125) having a reflective outer surface (130). The lens cover (125) can be coupled to the mobile station (100) such that the lens cover (125) can rotate with respect to an attachment point between an open position in which the camera lens (115) is unobstructed by the lens cover (125) and a closed position in which the camera lens (115) is obstructed by the lens cover (125).

### BACKGROUND OF THE INVENTION

1. Field of the Invention

The present invention relates to a mobile station having an integrated digital camera and camera lens cover.

2. Background of the Invention

Mobile stations, such as mobile phones and other wireless communication devices, are becoming increasingly complex. Useful new features are being added to mobile stations with each passing month. As an example, many mobile stations have come to include a digital camera. Typically, the camera is integrated in that the camera is disposed within the mobile station as opposed to being an add-on component. The lens of the camera usually is flush mounted with an exterior surface of the mobile station casing. Positioned in this manner, the camera is readily available for taking pictures.

While convenient, this positioning leaves the camera vulnerable to a variety of different hazards. One hazard is the possibility that the camera lens will be damaged. If the mobile station is dropped or struck against a hard surface, for example, the camera lens may become scratched or even crack. Another hazard is exposure of the camera lens to dirt and debris. While this exposure may damage the camera lens, dirt and debris are more likely to lead to blurry or otherwise substandard pictures. To minimize the chances of scratching the lens or taking blurry pictures, the user must continually clean the camera lens.

### SUMMARY OF THE INVENTION

The present invention relates to a mobile station having an integrated digital camera and a camera lens cover. One arrangement of the present invention can include a mobile station having an integrated camera, a camera lens disposed in the mobile station, and a lens cover having a reflective outer surface. The lens cover can be rotatably coupled to the casing. Accordingly, the lens cover can rotate with respect to an attachment point between an open position in which the camera lens is unobstructed by the lens cover and a closed position in which the camera lens is obstructed by the lens cover.

The lens cover can be circular in shape such that when closed, the lens cover completely obstructs the camera lens. When the camera lens is directed at the user of the mobile station and the lens cover is in the open position, images reflected in the reflective outer surface of the lens cover can approximate those objects located in the field of view of the camera lens.

The lens cover can be manually or automatically operated. In one arrangement, the attachment point can be a pin. In that case, the lens cover can be coupled to the mobile station via the pin and an actuator can be included in the mobile station. The actuator can be coupled to the pin such that the actuator can drive rotation of the pin and lens cover responsive to events detected within the mobile station.

Another arrangement of the present invention can include a mobile station having an integrated camera, a casing, a camera lens integrated into the casing, a pin extending through the casing at a location proximate to the camera lens, and a lens cover coupled to the pin. The lens cover can rotate with respect to the pin thereby shielding the camera lens when in a closed position.

The lens cover can have a reflective outer surface. Further, the lens cover can be circular in shape. The lens cover can rotate from an open position, where the camera lens is exposed, to a closed position, where the camera lens is obstructed by the lens cover.

As noted, the lens cover can be manually operated or automatically operated. In one arrangement, the pin and the lens cover can be coupled such that rotation of the pin causes rotation of the lens cover. The mobile station further can include an actuator coupled to the pin. The actuator can cause rotational motion of the pin and lens cover between an open position and the closed position.

The mobile station also can include a controller coupled to the actuator. The controller can signal the actuator to rotate the pin responsive to detecting an event within the mobile station. If the mobile station is a flip-style mobile station, in one arrangement, the controller can signal the actuator responsive to an opening or a closing of the mobile station.

In another arrangement, the mobile station can include a mechanical actuating mechanism coupled to the lens cover. The mechanical actuating mechanism can cause the lens cover to rotate between the open position and the closed position.

As noted, when the camera lens is directed at the user of the mobile station and the lens cover is in the open position, images reflected in the reflective outer surface of the lens cover can approximate those objects located in the field of view of the camera lens.

Yet another arrangement of the present invention can include a mobile station having an integrated camera, a camera lens disposed in the mobile station, a mechanical control operable by a user of the mobile station, and an arm coupled to the mechanical control. The mobile station further can include a lens cover coupled to the arm. Responsive to actuation of the mechanical control and motion of the arm, the lens cover can rotate with respect to the pin between an open position in which the camera lens is unobstructed by the lens cover and a closed position in which the camera lens is obstructed by the lens cover.

The lens cover can include a reflective outer surface. When the camera lens is directed at the user of the mobile station and the lens cover is in the open position, the lens cover can be proximate to the camera lens such that images reflected in the reflective outer surface of the lens cover can approximate those objects located in the field of view of the camera lens.

The arm can include two rods that are pivotally connected. When the lens cover is in the open position, the arm can be positioned in a substantially straight line. When the lens cover is in the closed position, the two rods can form an angle that is less than 180 degrees with the pivotal connection between the two rods forming the vertex of the angle.

### BRIEF DESCRIPTION OF THE DRAWINGS

Preferred embodiments of the present invention will be described below in more detail, with reference to the accompanying drawings, in which:

FIG. 1 depicts a mobile station having an integrated digital camera which is useful for understanding the present invention;

FIG. 2 depicts a sectional view of the mobile station of FIG. 1 taken along section line 2-2;

FIG. 3 depicts a mobile station having an integrated digital camera which is useful for understanding the present invention;

FIG. 4 depicts an enlarged partial view of the mobile station of FIG. 3; and

FIG. 5 depicts an enlarged partial view of the mobile station of FIG. 3.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a mobile station having an integrated digital camera and moveable lens cover. The inventive arrangements disclosed herein provide a moveable lens cover that can be moved to an open position to expose the camera lens and a closed position which obstructs the camera lens. When in the closed position, the lens cover can protect the camera lens from damage and can prevent exposure of the camera lens to debris. The lens cover further can include a reflective outer surface. The reflective outer surface allows a user to approximate the objects in the field of view of the camera lens, by virtue of the images reflected in the outer surface of the lens cover, when the camera lens is directed toward the user.

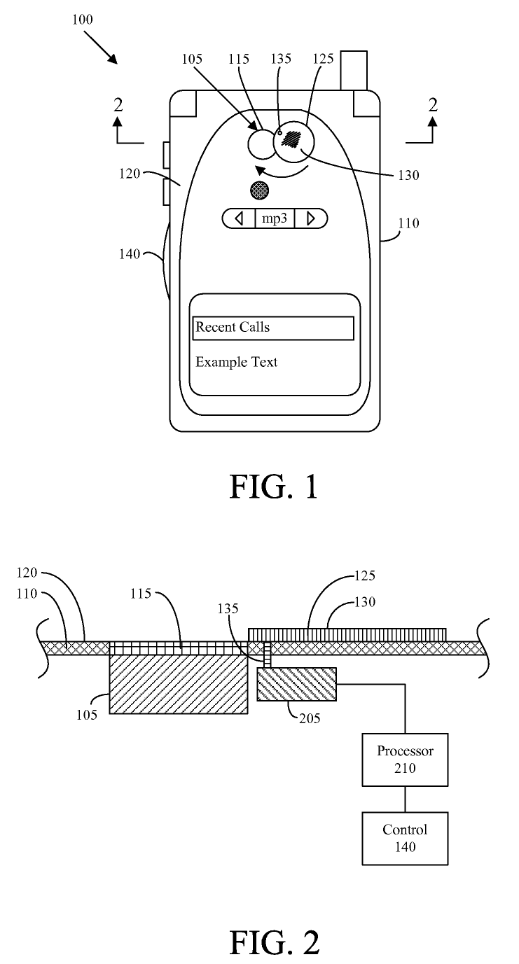

FIG. 1 depicts a mobile station 100 having an integrated digital camera 105 which is useful for understanding the present invention. The mobile station 100 can include a casing 110, the camera 105 having a camera lens 115, and a lens cover 125. It should be appreciated that while the mobile station 100 is depicted as a flip-style mobile phone, the particular styling of the mobile station 100 is not intended to limit the present invention. For example, a non-flip style mobile station can be used where the camera lens 115 is located on the backside of the mobile station 100 or in some other location.

The camera 105 can be disposed within the mobile station 100 such that the camera lens 115 can be integrated into the casing 110. In one arrangement, the camera lens 115 can be flush with an exterior surface 120 of the casing 110. In another arrangement, the camera lens 115 can be inset into the casing 115 such that the camera lens is disposed just below the exterior surface 120 of the casing 110.

The lens cover 125 can be located in a position that is approximately parallel with the exterior surface 120 of the casing 110. In one arrangement, the lens cover 125 can be circular in shape, though the invention is not intended to be limited by the particular shape of the lens cover 125. An outer surface 130 of the lens cover 125 can be reflective. In one arrangement, a reflective coating, mirror, or mirror-like material can be applied to the lens cover 125 to achieve the reflective outer surface 130. In another arrangement, the lens cover 125 can be comprised of, or fabricated from, a material having reflective properties such that the outer surface 130 is reflective. Utilizing a reflective lens cover 125 allows a user to point the camera lens 115 at himself or herself and visually determine the items in view of the camera lens 115 by virtue of which items are shown or reflected in the reflective outer surface 130 of the lens cover 125.

The lens cover 125 can be rotatably attached to the mobile station 100. More particularly, the lens cover 125 can be attached using a pin 135. In one arrangement, lens cover 125 can be fastened to the pin 135 such that both the pin 135 and the lens cover 125 rotate together. In another arrangement, the pin 135 can remain fixed such that the lens cover 125 can freely rotate about the pin 135. Regardless, the lens cover 125 can rotate in the direction indicated, i.e. clockwise, or in a counter-clockwise direction. As shown in FIG. 1, the lens cover 125 is set in an open position where the camera lens 115 is not obstructed or protected by the lens cover 125. The lens cover 125 can rotate to a closed position where the lens cover 125 completely obstructs the camera lens 115, thereby protecting the camera lens 115.

The lens cover 125 can be moved from the open position to the closed position and vice versa using any of a variety of different techniques. In one arrangement, the lens cover 125 can be moved manually by a user of the mobile station 100. That is, the user can move the lens cover 125 directly. In another arrangement, the lens cover 125 can be moved using a mechanical mechanism. In yet another arrangement, the lens cover 125 can be moved using an actuator such as an electronic motor or other powered mechanism.

In arrangements where the lens cover 125 is moved through mechanical means, electronic means, or through any combination thereof, the lens cover 125 can be moved responsive to different conditions, mobile station operating states, or stimuli, collectively referred to as events. In one arrangement, for example, the lens cover 125 can be opened automatically when the camera 105 is activated or the mobile station 100 is placed in a camera mode. Similarly, the lens cover 125 can be closed automatically when the camera 105 is deactivated or the mobile station 100 exits the camera mode.

In another arrangement, the lens cover 125 can be opened automatically responsive to actuation or activation of a control on the mobile station 100 such as a button 140, whether a mechanical button or an electronic button. Further actuation of the control or another control can cause the lens cover 125 to close automatically.

In an arrangement where the mobile station 100 is a flip-style mobile phone, the lens cover 125 can be opened automatically when the mobile station 100 is opened. The lens cover 125 can be closed automatically when the mobile station 100 is closed. The various events noted herein are provided for purposes of illustration only and, as such, are not intended to limit the present invention in any way. For instance, in the case of an electronically controlled lens cover 125, any of a variety of different events can be associated with, and therefore cause, the opening or closing of the lens cover 125.

FIG. 2 depicts a sectional view of the mobile station of FIG. 1 taken along section line 2-2. Though the lens cover 125 can be moved using any of a variety of different mechanisms, the sectional view of FIG. 2 illustrates an arrangement in which an actuator 205 causes the rotational motion of the lens cover 125 with respect to the pin 135. In any case, the lens cover 125 can be disposed above the exterior surface 120 of the casing 110. As shown, the lens cover 125 can be positioned substantially parallel with the exterior surface 120 of the mobile station 100 so as to allow the lens cover 125 to freely rotate over the exterior surface 120.

The lens cover 125 can rotate with the pin 135 in a clockwise direction to close and in a counter-clockwise direction to open. As noted, however, the lens cover 125 can be made to close with a counter-clockwise rotation and open with a clockwise rotation. It also should be appreciated that the lens cover 125 can be configured to rotate in only a single direction, i.e. either clockwise or counter-clockwise. In such an arrangement, the lens cover 125 can be partially rotated to the closed position. When activated again, the lens cover 125 can continue its rotation in the same direction until the lens cover 125 returns to the open position.

As noted, the lens cover 125 can have a reflective outer surface 130, whether such outer surface is achieved by layering a reflective material on the lens cover 125 or the lens cover 125 itself is fabricated from a reflective material.

In one arrangement, the actuator 205 can be implemented as an electronic motor capable of rotating the pin 135. The actuator 205 can operate under the control of a processor 210, i.e. a microprocessor, a controller, or other similar device. The processor 210 can provide control signals to the actuator 205 thereby causing the lens cover 135 to be rotated to an open or a closed position according to the control signals provided. Though the processor 210 can generate control signals responsive to a variety of different events, in the arrangement illustrated in FIG. 2, the processor 210 can cause the lens cover 135 to be rotated to the open position responsive to user activation of control 140. When in the open position, a further activation of control 140 can cause the processor 210 to signal the actuator 205 to rotate the lens cover 135 to the closed position.

In other arrangements, user activation of the control 140 can cause any of several actions to occur in the mobile station. For example, responsive to a first activation of the control 140, the mobile station can be placed in a camera mode. The lens cover 125 can be automatically opened and the camera 105 can take a picture. Responsive to a subsequent user activation of the control 140, the lens cover 125 can be closed and the mobile station can exit the camera mode.

The arrangements discussed above are not intended to limit the present invention, but rather to illustrate additional arrangements within the spirit of the present invention. Still, other arrangements also are within the scope of the present invention. For example, in yet another arrangement, opening and closing of the lens cover 125 can be performed responsive to a user activating and holding the control 140 for at least a minimum time period. While the lens cover 125 is in the open position, further activation(s) of control 140, where the user does not engage the control 140 for the minimum time period, can cause the camera 105 to take a picture.

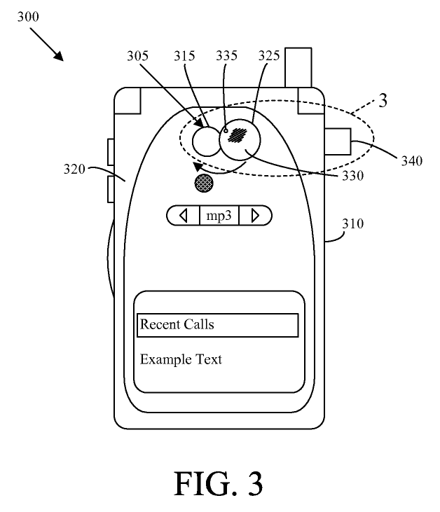

FIG. 3 depicts a mobile station 300 having an integrated digital camera 305 which is useful for understanding the present invention. The mobile station 300 is similar to that illustrated with reference to FIG. 1. As shown, the mobile station 300 can include a casing 310, the camera 305 having a camera lens 315, and a lens cover 325. The lens cover 325 can be attached to the mobile station 300 via a pin 335, with the lens cover 325 being located above an exterior surface 320 of the casing 310. Further, an outer surface 330 of the lens cover 325 can be reflective. FIG. 3 illustrates an arrangement that utilizes a mechanical control 340, i.e. a button, which when activated and deactivated, causes the lens cover 325 to rotate between the opened position and the closed position.

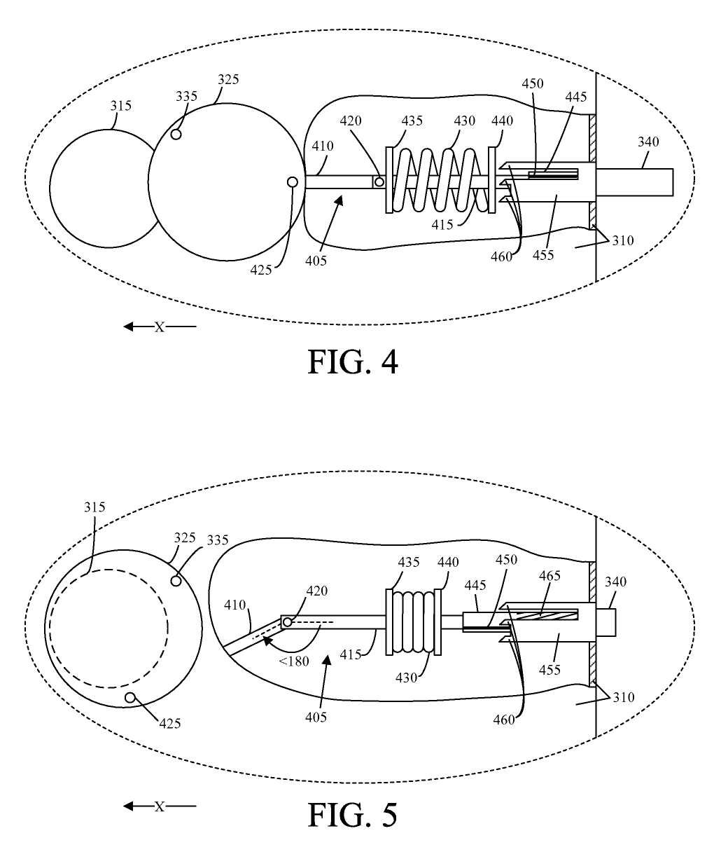

FIG. 4 depicts an enlarged partial view of the mobile station 300 of FIG. 3. FIG. 4 depicts the mobile station 300 with the lens cover 325 in the open position. As shown, a portion of the casing 310 is presented in cutaway view. The lens cover 325 can be coupled to an arm 405 via a pin 425 or other hinged mechanism. The arm 405 can include two rods 410, 415 that are coupled together through a hinge 420, i.e. a pin or other type of joint which allows rotational motion of one rod 410 about rod 415 with respect to the hinge 420. The pin 425 allows the lens cover 325 to rotate about the end of the rod 410 to which the lens cover 325 is attached.

Rod 415 can extend through a spring 430. On each end of the spring 430 can be stops 435, 440. Stop 435 can be attached to some inner portion of the mobile station, but not to the rod 415. Accordingly, rod 415 can extend through stop 435 and move freely in the “X” direction and back through stop 435 responsive to actuation of button 340 by a user. Stop 440 can be coupled to the rod 415. Although rod 415 can pass through stop 440, when rod 415 moves due to actuation of the button 340, the stop 440 moves in the “X” direction with the rod 415 thereby compressing spring 430 and providing resistance to the button 340.

Disposed within the casing 310 can be a cylinder 445. The cylinder 445 can include a hollow portion which can receive and engage the end of rod 415. Movement from the button 340 can be transferred to the cylinder 445 and on to the rod 415. The cylinder can include a plurality of fins 450, i.e. teeth. The cylinder 445 can be included within a guide 455. The guide 455 can be coupled to the casing 310 or other portion of the mobile station such that the guide 455 remains stationary and does not move with actuation of the button 340.

The guide 455 can be cylindrical in shape and can be hollow to accommodate the cylinder 445. As shown, the guide 455 can include a plurality of teeth 460 forming a pattern of alternating shallow and deep slots for receiving the fins 450 of the cylinder 445. The cylinder 445 can include a threaded portion (not shown). The interior surface (not shown) of the guide 455 also can be threaded such that the threaded portion of the cylinder 455 can cooperatively engage the threaded interior surface of the guide 455 to cause circular, or rotational, motion of the cylinder 445 when the button 340 is actuated.

Actuation of the button 340 causes the cylinder 445 to rotate about an axis defined by the rod 415. The fins 450 can be guided into the slots of the guide 455 by the teeth 460. As noted, FIG. 4 illustrates the lens cover 325 in the open position. Accordingly, the fins 450 of the cylinder 445 are located within a deep slot of the guide 445.

FIG. 5 depicts an enlarged partial view of the mobile station 300 of FIG. 3. As shown, the button 340 has been actuated and the lens cover 325 is in the closed position thereby completely covering and protecting the lens 315. Motion of button 340 is transferred to cylinder 445 in the “X” direction. As cylinder 445 moves with the button 340 in the “X” direction, cylinder 445 rotates due to the threaded portion 465 being cooperatively engaged with the inner threaded surface of the guide 455. The cylinder 445 moves in the “X” direction, thereby extricating the fins 450 from the deep slot. The rotational motion of the cylinder 445 causes the fins 450 to rotate, also guided by teeth 460, into a shallow slot of the guide 455 as shown.

The spring 430 compresses as stop 440, which is attached to rod 415, moves in the “X” direction. As noted, stop 435 is coupled to the mobile station or some other structure within the mobile station so as to prevent movement. Rod 415, however, as discussed, is permitted to move through the stop 435 in the “X” direction and back in the opposite direction.

Movement of rod 415 in the “X” direction causes rod 410 to rotate the lens cover 325 about pin 335, thereby moving lens cover 325 into the closed position to obstruct the lens 315. As shown, rod 410 can rotate, at least to a limited degree, about hinge 420 which facilitates the rotation of lens cover 325. When in the closed position, rods 410 and 415 form an angle that is less than 180 degrees where the hinge 420 is considered the vertex. This can be viewed in contrast to the positioning of rods 410, 415 when the lens cover 325 is in the open position. In the open position, rods 410, 415 can be positioned along a substantially straight line as shown with reference to FIG. 4.

The arrangements disclosed herein provide a lens cover for a mobile station having an integrated digital camera. The lens cover can include a reflective outer surface, thereby allowing the lens cover to provide several different functions. The lens cover can protect the camera lens when not in use thereby preventing damage to the camera lens and preventing debris from accumulating on the camera lens. Further, when the camera is in use and the camera lens is directed toward the user, the user can determine which objects are in view of the camera lens by looking at the images reflected in the lens cover.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically, i.e. communicatively linked through a communication channel or pathway.

This invention can be embodied in other forms without departing from the spirit or essential attributes thereof. Accordingly, reference should be made to the following claims, rather than to the foregoing specification, as indicating the scope of the invention.

What is claimed is:

1. A mobile station having an integrated camera, the mobile station comprising:
a camera lens disposed in the mobile station; and
a lens cover having a reflective outer surface, wherein the lens cover is rotatably coupled to the mobile station, wherein the lens cover rotates with respect to an attachment point with the mobile station between an open position in which the camera lens is unobstructed by the lens cover and a closed position in which the camera lens is obstructed by the lens cover.

2. The mobile station of claim 1, wherein the lens cover is circular in shape and, when in the closed position, completely obstructs the camera lens.

3. The mobile station of claim 1, wherein when the lens cover is in the open position and the camera lens is directed at the user of the mobile station, images reflected in the reflective outer surface of the lens cover approximate objects located in a field of view of the camera lens.

4. The mobile station of claim 1, wherein the attachment point is a pin that couples the lens cover to the mobile station, the mobile station further comprising an actuator coupled to the pin, wherein the actuator drives rotation of the pin and the lens cover responsive to events detected within the mobile station.

5. The mobile station of claim 1, wherein the lens cover is manually operated.

6. A mobile station having an integrated camera, the mobile station comprising:
a casing;
a camera lens integrated into the casing;
a pin extending through the casing at a location proximate to the camera lens; and
a lens cover coupled to the pin such that the lens cover rotates with respect to the pin thereby shielding the camera lens when in a closed position.

7. The mobile station of claim 6, wherein the lens cover has a reflective outer surface.

8. The mobile station of claim 7, wherein the lens cover is circular in shape.

9. The mobile station of claim 6, wherein the lens cover rotates from an open position wherein the camera lens is exposed to a closed position wherein the camera lens is obstructed by the lens cover.

10. The mobile station of claim 9, wherein the lens cover is manually operated.

11. The mobile station of claim 6, wherein the pin and the lens cover are coupled such that rotation of the pin causes rotation of the lens cover, the mobile station further comprising an actuator coupled to the pin, wherein the actuator causes rotational motion of the pin and lens cover between an open position and the closed position.

12. The mobile station of claim 11, further comprising a controller coupled to the actuator, wherein the controller signals the actuator to rotate the pin responsive to detecting an event within the mobile station.

13. The mobile station of claim 12, wherein the mobile station is a flip-style mobile station, wherein the controller signals the actuator responsive to an opening or a closing of the mobile station.

14. The mobile station of claim 6, further comprising a mechanical actuating mechanism coupled to the lens cover, wherein the mechanical actuating mechanism causes the lens cover to rotate between an open position and the closed position.

15. The mobile station of claim 6, wherein when the camera lens is directed at the user of the mobile station and the lens cover is in the open position, images reflected in the reflective outer surface of the lens cover approximate objects located in a field of view of the camera lens.

16. A mobile station having an integrated camera, the mobile station comprising:
a camera lens disposed in the mobile station;
a mechanical control operable by a user of the mobile station;
an arm coupled to the mechanical control; and
a lens cover coupled to the arm, wherein, responsive to actuation of the mechanical control and motion of the arm, the lens cover rotates with respect to an attachment point with the mobile station between an open position in which the camera lens is unobstructed by the lens cover and a closed position in which the camera lens is obstructed by the lens cover.

17. The mobile station of claim 16, wherein the lens cover has a reflective outer surface.

18. The mobile station of claim 16, wherein when the camera lens is directed at the user of the mobile station and the lens cover is in the open position, images reflected in the reflective outer surface of the lens cover approximate objects located in a field of view of the camera lens.

19. The mobile station of claim 16, wherein the arm is comprised of two rods that are pivotally connected, wherein when the lens cover is in the open position, the arm is positioned in a substantially straight line.

20. The mobile station of claim 16, wherein the arm is comprised of two rods that are pivotally connected, wherein when the lens cover is in the closed position, the two rods form an angle less than 180 degrees with the pivotal connection between the two rods forming the vertex of the angle.
